(19) United States
(12) Patent Application Publication
(10) Pub. No.: US 2026/0037197 A1
(43) Pub. Date: Feb. 5, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: KENTO KAWAI, Kanagawa (JP)

(21) Appl. No.: 19/285,282

(22) Filed: Jul. 30, 2025

(30) Foreign Application Priority Data
Aug. 1, 2024 (JP) 2024-125976

(51) Int. Cl. G06F 3/12

(52) U.S. Cl. CPC G06F 3/1256; G06F 3/1208

(57) ABSTRACT

A method of controlling an information processing apparatus that communicates with a printing apparatus, the method includes acquiring information about the printing apparatus from the printing apparatus, controlling the information processing apparatus to display a print preview screen for a user to check a print setting that has been changed based on the information about the printer that is acquired from the printing apparatus, and instructing the printing apparatus to perform printing in response to a reception of an instruction to perform printing on the print preview screen.

### BACKGROUND

### Field of the Technology

The present disclosure relates to an information processing apparatus, a control method, and a storage medium.

### Description of the Related Art

Terminals transmit jobs to image processing apparatuses, and the image processing apparatuses can perform functions based on the jobs. For example, when a user instructs an image processing apparatus to print the print data on an image, a document, or the like, from a terminal by using an application or the like, functions can be used of displaying a preview of the print data and of allowing the user to change the print settings. Japanese Patent Application Laid-Open No. 2002-229748 discusses a technique in which a terminal acquires capability information from a printer to display a setting screen that allows the user to configure print settings based on the acquired capability information.

When the user issues a job execution instruction to an image processing apparatus from the terminal or the like, it is necessary for the user to appropriately understand the job settings.

### SUMMARY

The present disclosure is directed to providing a method that enables a user to appropriately understand job settings when the user instructs an image processing apparatus to execute a job from a terminal or the like.

According to an aspect of the present disclosure, a method of controlling an information processing apparatus that communicates with a printing apparatus, the method includes acquiring information about the printing apparatus from the printing apparatus, controlling the information processing apparatus to display a print preview screen for a user to check a print setting that has been changed based on the information about the printer that is acquired from the printing apparatus, and instructing the printing apparatus to perform printing in response to a reception of an instruction to perform printing on the print preview screen.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration example of an information processing apparatus and a communication apparatus according to a first exemplary embodiment of the present disclosure.

FIG. 2 is a diagram illustrating an example of a connection state of the information processing apparatus and the communication apparatus according to the present exemplary embodiment of the present disclosure.

FIG. 3 is a diagram illustrating an example of a screen for determining a selected printer and receiving instructions to start each function according to the present exemplary embodiment of the present disclosure.

FIGS. 4A and 4B are diagrams each illustrating an example of a screen displayed by an application according to the present exemplary embodiment of the present disclosure.

FIGS. 5A and 5B are diagrams each illustrating an example of a screen displayed by the application according to the present exemplary embodiment of the present disclosure.

FIGS. 6A to 6D are diagrams each illustrating an example of a screen displayed by the application according to the present exemplary embodiment of the present disclosure.

FIGS. 7A and 7B are diagrams each illustrating an example of a screen displayed by the application according to the present exemplary embodiment of the present disclosure.

FIG. 8 is a flowchart illustrating an example of processing of the application according to the present exemplary embodiment of the present disclosure.

FIG. 9 is a flowchart illustrating an example of the processing of the application according to the present exemplary embodiment of the present disclosure.

FIG. 10 is a flowchart illustrating an example of the processing of the application according to the present exemplary embodiment of the present disclosure.

FIG. 11 is a flowchart illustrating an example of the processing of the application according to the present exemplary embodiment of the present disclosure.

FIG. 12 is a flowchart illustrating an example of the processing of the application according to the present exemplary embodiment of the present disclosure.

FIG. 13 is a flowchart illustrating an example of the processing of the application according to the present exemplary embodiment of the present disclosure.

FIG. 14 is a flowchart illustrating an example of the processing of the application according to the present exemplary embodiment of the present disclosure.

### DESCRIPTION OF THE EMBODIMENTS

An exemplary embodiment of the present disclosure will be described in detail with reference to the accompanying drawings. The following exemplary embodiment does not limit the present disclosure according to the claims, and all of combinations of features described in the exemplary embodiment are not necessarily essential for solving means of the present disclosure.

A first exemplary embodiment will now be described. An information processing apparatus and a communication apparatus included in a communication system according to the present exemplary embodiment will be described. In the present exemplary embodiment, a smartphone is exemplified as the information processing apparatus. However, the information processing apparatus is not limited thereto, and may be applied to various apparatuses, such as a mobile terminal, a laptop personal computer (PC), a tablet terminal, a personal digital assistant (PDA), and a digital camera. In the present exemplary embodiment, a printer is exemplified as the communication apparatus. However, the communication apparatus is not limited thereto, and may be applied to various apparatuses as long as the apparatus can perform wireless communication with the information processing apparatus. In the case of a printer, the present exemplary embodiment is applicable to, for example, an inkjet printer, a full-color laser beam printer, and a monochrome printer. Further, the present exemplary embodiment is applicable to a copier, a facsimile (FAX) device, a mobile terminal, a smartphone, a laptop PC, a tablet terminal, a PDA, a digital camera, a music player, a television, a smart speaker, and the like. In addition, the present exemplary embodiment is applicable to a multifunctional peripheral with a plurality of functions, such as a copy function, a FAX function, and a printing function.

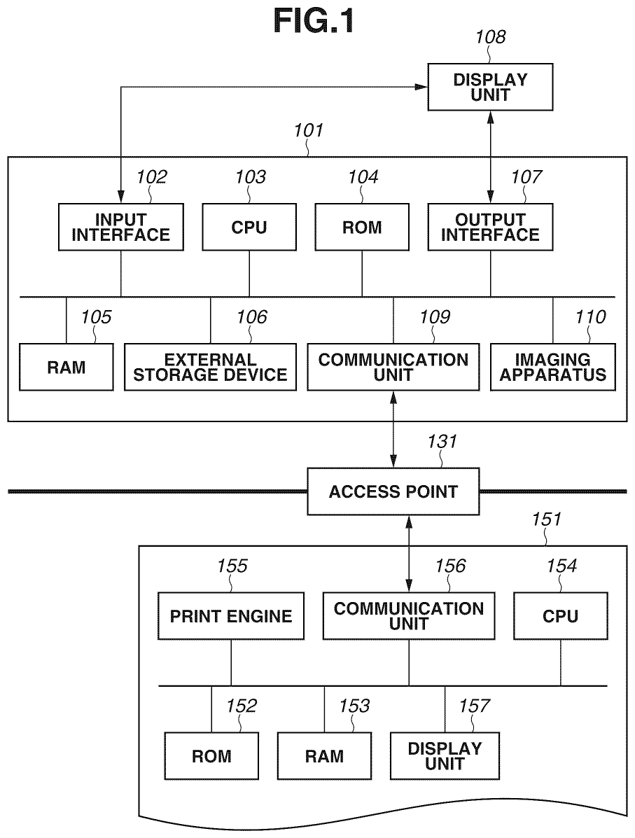

A configuration of the information processing apparatus according to the present exemplary embodiment, and a configuration of the communication apparatus that can communicate with the information processing apparatus according to the present exemplary embodiment will be described with reference to the block diagram in FIG. 1. In the present exemplary embodiment, the following configurations are described as examples. However, the present exemplary embodiment is applicable to any apparatus that can communicate with the communication apparatus, and the functions are not particularly limited to the illustrated functions.

An information processing apparatus 101 is the information processing apparatus according to the present exemplary embodiment. The information processing apparatus 101 includes an input interface 102, a central processing unit (CPU) 103, a read-only memory (ROM) 104, a random-access memory (RAM) 105, an external storage device 106, an output interface 107, a display unit 108, a communication unit 109, and an imaging apparatus 110. It is on the assumption that the information processing apparatus 101 is a device, such as a smartphone. However, the information processing apparatus 101 is not limited to a smartphone.

The input interface 102 receives data inputs and operation instructions from a user, and includes a physical keyboard, buttons, and a touch panel. The output interface 107 described below and the input interface 102 can be configured as an identical component, and screen output and user input reception can be performed by that component.

The CPU 103 is a system control unit that controls the entire information processing apparatus 101.

The ROM 104 stores fixed data, such as control programs to be executed by the CPU 103, data tables, and a built-in operating system (hereinafter, referred to as an OS) program. In the present exemplary embodiment, the control programs stored in the ROM 104 perform software execution control, such as scheduling, task switching, and interruption processing, under the control of the built-in OS program stored in the ROM 104.

The RAM 105 includes a static random-access memory (SRAM) requiring backup power supply. The RAM 105 retains data using a not-illustrated primary battery for data backup, and thus can store important data, such as program control variables, in a nonvolatile manner. A memory area for storing setting information on the information processing apparatus 101, management data on the information processing apparatus 101, and the like is provided in the RAM 105. The RAM 105 is also used as the main memory and a working memory for the CPU 103.

The external storage device 106 includes an application (a print application described below) that provides a function of instructing an external device to perform printing or scanning. The external storage device 106 further includes various kinds of programs, such as a print information generation program that generates print information interpretable by a communication apparatus 151, and an information transmission and reception control program that performs the transmissions and receptions of information with the communication apparatus 151 connected via the communication unit 109. The external storage device 106 stores various kinds of information to be used by the programs, and image data obtained from other information processing apparatuses and the Internet.

The output interface 107 controls the display unit 108 to perform display of data and notification of a state of the information processing apparatus.

The display unit 108 includes a light-emitting diode (LED) and a liquid crystal display (LCD), and performs display of the data and the notification of the state of the information processing apparatus 101. User inputs can be received via the display unit 108 provided with a software keyboard that includes keys, such as numeric input keys, mode setting keys, a determination key, a cancel key, and a power key.

The communication unit 109 is connected to an apparatus, such as the communication apparatus 151, to perform data communication. For example, the communication unit 109 may perform direct wireless communication with the communication apparatus 151 without an external access point, or may perform communication via an external access point (an access point 131) outside the information processing apparatus 101 and the communication apparatus 151.

The access point is a device that establishes a network and determines a communication channel used in communication within the established network. In the present exemplary embodiment, as a wireless communication method of the communication unit 109, Wireless Fidelity (Wi-Fi®) is used, but Bluetooth® or the like can be used. As the access point 131, an apparatus, such as a wireless local area network (LAN) router, can be used. In the present exemplary embodiment, a method in which the information processing apparatus 101 and the communication apparatus 151 are directly connected without the external access point is referred to as a direct connection method.

A method in which the information processing apparatus 101 and the communication apparatus 151 are connected via the external access point is referred to as an infrastructure connection method.

The imaging apparatus 110 converts images captured by an imaging element into digital data. The digital data is once stored in the RAM 105. Thereafter, a program being executed by the CPU 103 converts the digital data into image data in a predetermined image format, and the image data is stored in the external storage device 106.

The communication apparatus 151 is the communication apparatus according to the present exemplary embodiment. The communication apparatus 151 includes a ROM 152, a RAM 153, a CPU 154, a print engine 155, a communication unit 156, and a display unit 157.

The communication unit 156 is connected to an apparatus, such as the information processing apparatus 101, to perform data communication. In the present exemplary embodiment, as a wireless communication method for the communication unit 156, Wi-Fi® is used. However, Bluetooth® Classic or the like can be used. The access point can be connected to the communication unit 109 of the information processing apparatus 101. A plurality of access points each having a different service set identifier (SSID) and a password may constitute an access point within the communication apparatus 151. In the present exemplary embodiment, the access point within the communication apparatus 151 includes at least a connection setting access point described below.

The RAM 153 includes a dynamic random-access memory (DRAM) requiring backup power supply. The RAM 153 retains data using a not-illustrated power supply for data backup, and can store important data, such as program control variables, in a nonvolatile manner. The RAM 153 is also used as the main memory and a working memory for the CPU 154, and stores a reception buffer for temporarily storing print information received from the information processing apparatus 101 and the like, and various kinds of information.

The ROM 152 stores fixed data, such as control programs, to be executed by the CPU 154, data tables, and a built-in OS program. In the present exemplary embodiment, the control programs stored in the ROM 152 perform software execution control, such as scheduling, task switching, and interruption processing under the control of the built-in OS program stored in the ROM 152. Further, a memory area for storing data required to be retained even when power is not supplied, such as setting information on the communication apparatus 151 and management data on the communication apparatus 151, is also provided in the ROM 152.

The CPU 154 is a system control unit that controls the entire communication apparatus 151.

The print engine 155 forms images on recording media, such as paper, using recording agent, such as ink, based on information stored in the RAM 153 or print jobs received from the information processing apparatus 101 or the like to output the print results.

The display unit 157 includes an LED and an LCD, and performs display of data and notification of a state of the communication apparatus 151. User inputs may be received via the display unit 157 provided with a software keyboard that includes keys, such as numeric input keys, mode setting keys, a determination key, a cancel key, and a power key.

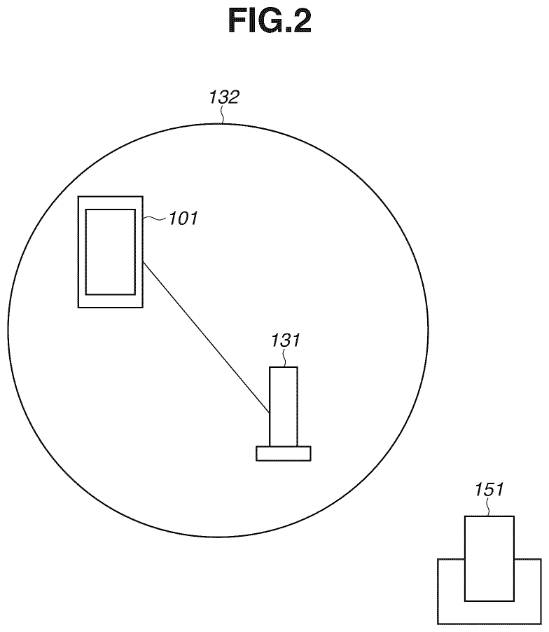

FIG. 2 is a diagram illustrating a configuration of a print processing system. Around the access point 131, the system includes the information processing apparatus 101 and the communication apparatus 151 that are connectable to the access point 131. FIG. 2 illustrates a state where the information processing apparatus 101 alone is connected to the access point 131 in a network 132 of an infrastructure mode established by the access point 131. The communication apparatus 151 is yet to be a part of the network 132, and requires connection setting processing to participate in the network 132.

When the communication apparatus 151 is connected to the access point 131, the information processing apparatus 101 and the communication apparatus 151 can be connected via the access point 131.

The access point 131 and the communication apparatus 151 can be connected via a wireless LAN, but may be connected via a wired LAN. The access point 131 and the information processing apparatus 101 can also be connected via the wireless LAN. The communication apparatus 151 includes an access point mode. When the access point mode is enabled, the information processing apparatus 101 and the communication apparatus 151 can perform peer-to-peer communication via the wireless LAN. When the access point mode is enabled, the information processing apparatus 101 and the communication apparatus 151 perform peer-to-peer communication by using the access point included in the communication apparatus 151. In parallel with the peer-to-peer communication between the information processing apparatus 101 and the communication apparatus 151 by using the access point included in the communication apparatus 151, the communication apparatus 151 may perform communication with the access point 131. In other words, the communication in the infrastructure mode and the direct communication can be simultaneously performed. Further, it is determined based on a user instruction whether the communication apparatus 151 enables the access point mode alone or both the access point mode and communication with the access point 131.

### <Configuration of Display Screen>

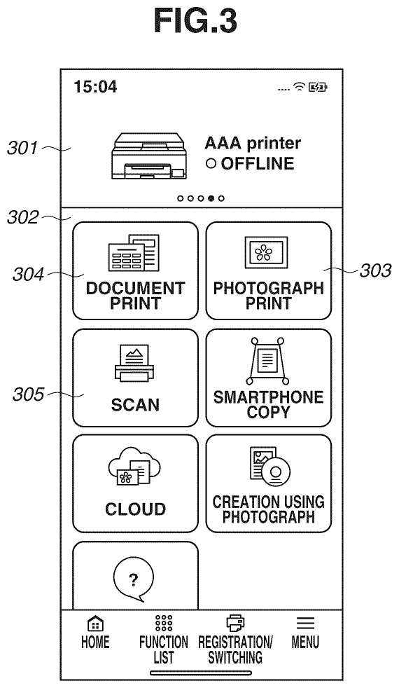

Operation of the print application in the information processing apparatus 101 will now be described with reference to FIG. 3. FIG. 3 illustrates a screen of the print application displayed on the display unit 108 of the information processing apparatus 101. The screen illustrated in FIG. 3 includes a printer display area 301 for displaying information on a printer that is a job execution instruction target of the print application, and a function area 302 for selecting a function to be performed. When any of displayed items corresponding to respective functions included in the function area 302 is selected, the screen transitions to a setting screen or the like of the selected function, and a function execution instruction is issued to the printer after the setting is performed. The printer display area 301 displays an icon, a model name, and the state of a printer selected by the user from among printers registered in the print application.

Information displayed in the printer display area 301 is updated when the selected printer is changed by a user operation. The printer displayed in the printer display area 301 is selected by the user and is the target printer of a job execution instruction. In this case, the target printer is the communication apparatus 151. The function area 302 may display a list of functions available on the selected printer (i.e., the printer displayed in printer display area 301). The functions displayed in the function area 302 are updated when the selected printer is changed by user operation. The function area 302 includes a photograph printing function button 303 for printing a photograph, a document printing function button 304 for printing a document, and a scanning function button 305 for performing scanning.

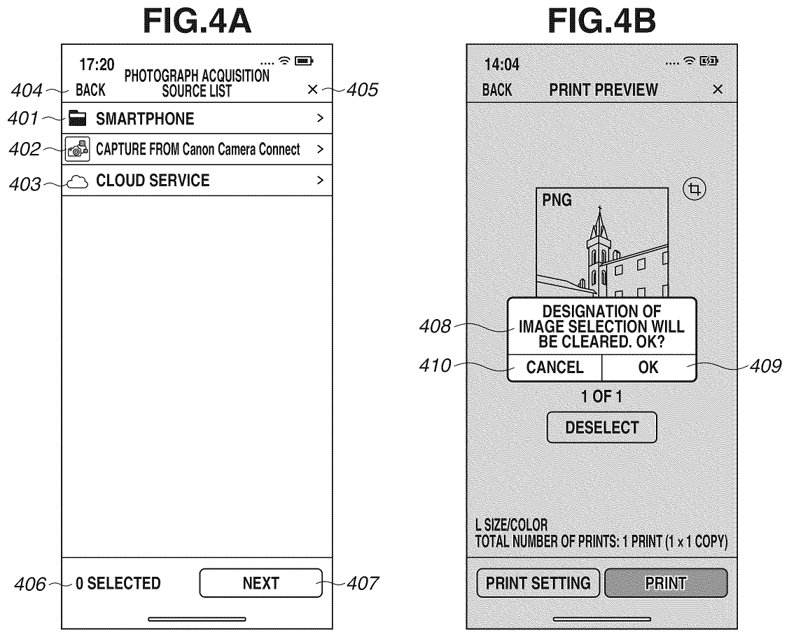

When a selection of the photograph printing function button 303 is received, a list screen of photograph acquisition sources illustrated in FIG. 4A is displayed on the display unit 108.

FIG. 4A illustrates the list screen of photograph acquisition sources that displays an in-terminal image selection button 401, an in-another-application image selection button 402, a cloud-service image selection button 403, a back button 404, a close button 405, a selected image count display field 406, and a next button 407.

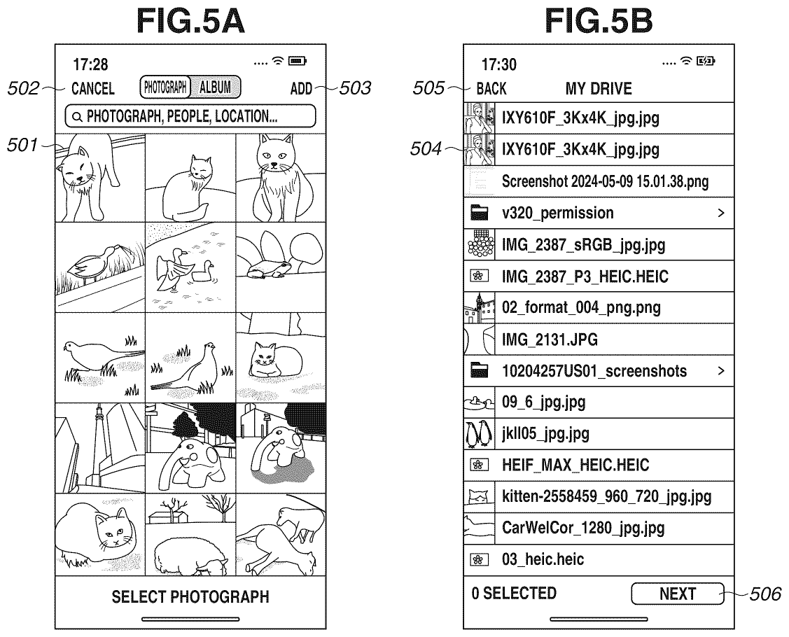

The in-terminal image selection button 401 displays a screen for selecting an image to be printed from among images stored in the information processing apparatus 101. When a selection of the in-terminal image selection button 401 is received, a screen illustrated in FIG. 5A is displayed on the display unit 108 of the information processing apparatus 101.

In the present exemplary embodiment, the in-another-application image selection button 402 displays a screen for selecting an image to be printed from among images captured by a camera with another application. When a selection of the in-another-application image selection button 402 is received, the information processing apparatus 101 opens an application other than the print application. A screen equivalent to the screen as illustrated in FIG. 5A for selecting an image is then displayed on the display unit 108 of the information processing apparatus 101.

The cloud-service image selection button 403 displays a screen for selecting an image to be printed from among images stored in the cloud service. When a selection of the cloud-service image selection button 403 is received, a screen illustrated in FIG. 5B is displayed on the display unit 108 of the information processing apparatus 101.

The back button 404 switches the screen to the previous screen. When a selection of the back button 404 is received, the screen illustrated in FIG. 3 is displayed on the display unit 108 of the information processing apparatus 101.

The close button 405 is used to end the function. When a selection of the close button 405 is received, the screen illustrated in FIG. 3 is displayed on the display unit 108 of the information processing apparatus 101.

The selected image count display field 406 displays the number of images selected to be printed using the photograph printing function. The selected image count display field 406 is updated every time the screen transitions to the list screen of photograph acquisition sources by a user operation.

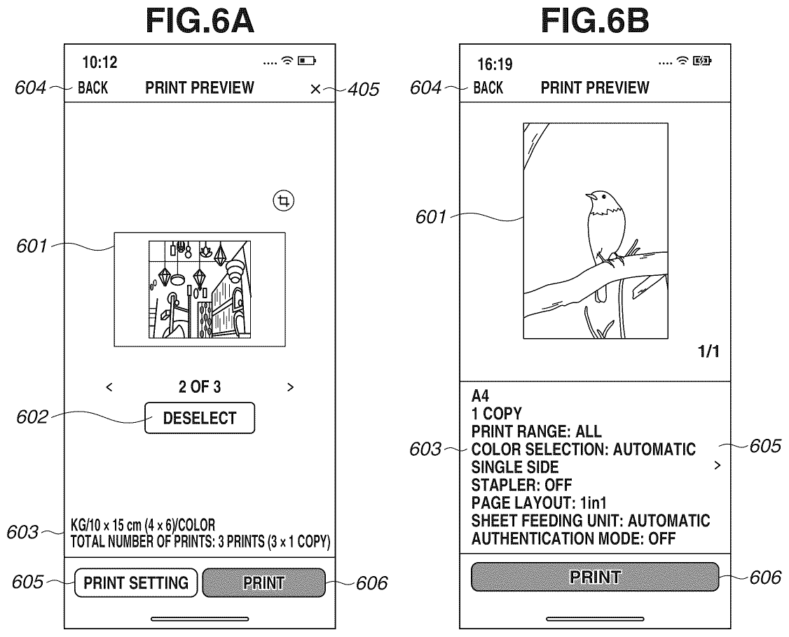

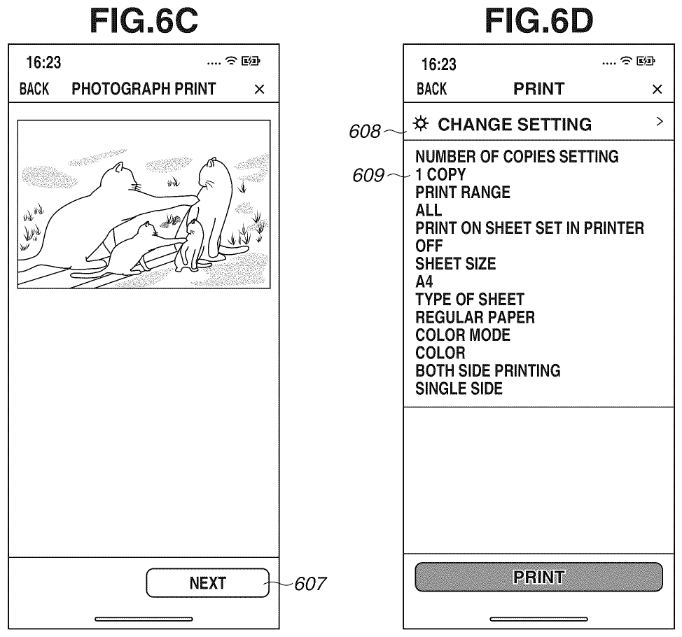

The next button 407 is disabled when no images are selected and serves as a button to transition to a print preview screen when at least one image is selected. When a selection of the next button 407 is received, a screen illustrated in FIG. 6A or FIG. 6B is displayed on the display unit 108 of the information processing apparatus 101.

FIG. 4B illustrates a screen displayed when, for example, the close button 405 is pressed on the print preview screen described below. In FIG. 4B, an image deselection dialog 408, an OK button 409, and a cancel button 410 are displayed on the print preview screen.

The image deselection dialog 408 displays a description indicating that the selected image to be printed stored in the print application is deselected.

The OK button 409 is used to deselect the selected image. When a selection of the OK button 409 is received, the selected image stored in the print application is deselected. The screen illustrated in FIG. 3 is then displayed on the display unit 108 of the information processing apparatus 101.

When a selection of the cancel button 410 is received, the image deselection dialog 408 is closed and the image is not deselected.

In the screen illustrated in FIG. 5A, an image selection area 501, a back button 502, and an add button 503 are displayed.

The image selection area 501 displays a list of images stored in the information processing apparatus 101. The user selects an image to be printed from among thumbnails of the images displayed in the image selection area 501. At this time, a single image or a plurality of images can be selected.

The back button 502 is used to switch the screen to the previous screen. When a selection of the back button 502 is received, the screen illustrated in FIG. 4A is displayed on the display unit 108 of the information processing apparatus 101.

The add button 503 is used to add an image selected from the image selection area 501 as an image to be printed and is enabled when one or more images are selected in the image selection area 501. When a selection of the add button 503 is received, the image selected from the image selection area 501 is stored as the image to be printed in the print application, and the screen illustrated in FIG. 4A is displayed on the display unit 108 of the information processing apparatus 101.

In the screen illustrated in FIG. 5B, an image selection area 504, a back button 505, and a next button 506 are displayed.

The image selection area 504 displays a list of images stored in the cloud service. The user selects an image to be printed from among thumbnails of the images displayed in the image selection area 504. At this time, a single image or a plurality of images can be selected.

The back button 505 is used to switch the screen to the previous screen. When a selection of the back button 505 is received, the screen illustrated in FIG. 4A is displayed on the display unit 108 of the information processing apparatus 101.

The next button 506 is used to add an image selected from the image selection area 504 as an image to be printed and is enabled when one or more images are selected in the image selection area 504. When a selection of the next button 506 is received, the image selected from the image selection area 504 is stored as an image to be printed in the print application and the screen illustrated in FIG. 6A or 6B is displayed on the display unit 108 of the information processing apparatus 101.

FIGS. 6A and 6B each illustrate an example of a print preview screen for the user to check the image to be printed and the print settings. The print preview screen that includes a preview area 601, an image deselection button 602, a print setting display field 603, a back button 604, a print setting button 605, a print button 606, and a close button 405 is displayed on the display unit 108.

The print preview screen illustrated in FIG. 6A or the print preview screen illustrated in FIG. 6B is displayed depending on the printer (the target printer) displayed in the printer display area 301. For example, when the target printer is not an electrophotographic printer (e.g., is an inkjet printer), the print preview screen illustrated in FIG. 6A is displayed, whereas when the target printer is an electrophotographic printer, the print preview screen illustrated in FIG. 6B is displayed. In other words, the print preview screen to be displayed varies depending on the type of the target printer. When the target printer is an electrophotographic printer, detailed print settings as displayed in the print setting display field 603 in FIG. 6B can be checked. When the target printer is an inkjet printer, minimum print settings alone as displayed in the print setting display field 603 in FIG. 6A can be checked. The condition for determining whether the print preview screen illustrated in FIG. 6A or 6B is displayed may be based on a condition other than whether the target printer is an electrophotographic printer. For example, the condition may be whether the target printer is an office printer or a home printer, or whether the target printer belongs to a predetermined product series.

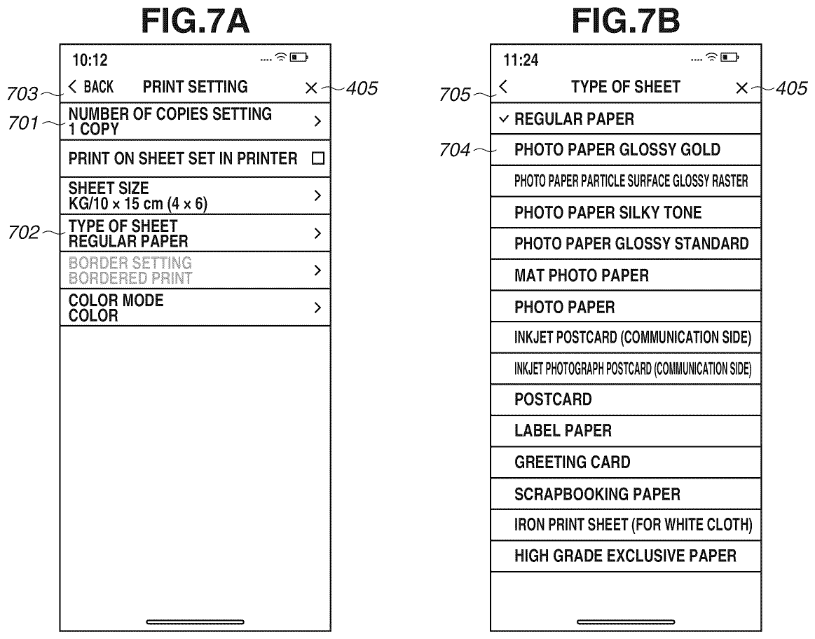

The display items in the print setting display field 603 may be configured to have the same function as that of the print setting button 605, and when the print setting display field 603 is pressed, the same operation can be performed as when the print setting button 605 is pressed. The print setting display field 603 can be divided for each print setting, and a screen equivalent to a print setting item screen illustrated in FIG. 7A can be displayed.

The preview area 601 displays the image selected as the image to be printed so that the user can confirm whether the image to be printed is correct. Further, the preview area 601 is configured to reflect the print settings configured by the user in the displayed image to enable the user to understand an image of the expected print result.

The image deselection button 602 is used to deselect the image being displayed in the preview area 601 from the images selected for printing. When a selection of the image deselection button 602 is received, the image displayed in the preview area 601 is removed from the selected images stored in the print application.

The print setting display field 603 displays print setting items and setting values of the selected print setting items. In the present exemplary embodiment, the print setting items and the setting values displayed in the print setting display field 603 are changed depending on the selected printer. For example, when the target printer is an electrophotographic printer, all configurable print setting items and setting values corresponding to the respective print setting items are displayed as illustrated in FIG. 6B. In contrast, when the target printer is an inkjet printer, from among the configurable print setting items, the main print setting items and the setting values corresponding to the print setting items are displayed. In this case, the displayed items include the sheet type, the size, color settings, and the number of copies. If setting values are not changed by a user operation, the default setting values are displayed.

The back button 604 is used to switch the screen to the previous screen. When a selection of the back button 604 is received, the screen illustrated in FIG. 4A is displayed on the display unit 108 of the information processing apparatus 101.

The print setting button 605 displays a print setting screen. When a selection of the print setting button 605 is received, a screen illustrated in FIG. 7A is displayed on the display unit 108 of the information processing apparatus 101.

The print button 606 is used to instruct the printer to perform printing. When a selection of the print button 606 is received, image data on the image stored as the image to be printed in the print application and the print settings are transmitted to the printer. When the printing is completed, the screen illustrated in FIG. 4A is displayed on the display unit 108 of the information processing apparatus 101.

FIGS. 6C and 6D each illustrate a print preview screen when the document printing function is used. In other words, FIGS. 6C and 6D each illustrate the print preview screen displayed after the document printing function button 304 is selected in the screen illustrated in FIG. 3 and the user selects a document file to be printed.

FIG. 6C illustrates the print preview screen for the user to confirm the image to be printed. FIG. 6D illustrates a screen that receives an instruction to transition to the print setting screen, which prompts the user to check the image settings.

A next button 607 is used to transition to the screen illustrated in FIG. 6D. When a selection of the next button 607 is received, the screen illustrated in FIG. 6D is displayed on the display unit 108 of the information processing apparatus 101.

A print setting button 608 displays the print setting screen. When a selection of the print setting button 608 is received, the screen illustrated in FIG. 7A is displayed on the display unit 108 of the information processing apparatus 101.

A print setting display field 609 displays print setting items and setting values of the selected print setting items. In document printing, identical print settings can be displayed across different printers irrespective of the target printer, or the displayed print setting can be changed depending on the target printer as in photograph printing. In document printing, for example, when the target printer is an inkjet printer, the print preview screen illustrated in FIG. 6D can be displayed, whereas when the target printer is an electrophotographic printer, the print preview screen illustrated in FIG. 6B can be displayed.

The print setting screen illustrated in FIG. 7A includes a print setting item display area 701, a back button 703, and the close button 405.

The print setting item display area 701 displays all print setting items available on the target printer. In the present exemplary embodiment, the print setting item display area 701 displays a button used to transition to a print setting item screen, similarly to a sheet type change button 702, for each setting item. In the present exemplary embodiment, when a selection of the sheet type change button 702 is received, a screen illustrated in FIG. 7B is displayed on the display unit 108 of the information processing apparatus 101. In this case, the print setting items available on the target printer are displayed on the print setting screen. However, a print setting screen including identical print settings across different printers can be displayed irrespective of the target printer. In other words, while the print setting information displayed on the print preview screen varies depending on the target printer, the print setting information displayed on the print setting screen can be configured to remain unchanged irrespective of the target printer.

The back button 703 is used to switch the screen to the previous screen. When a selection of the back button 703 is received, the screen illustrated in FIG. 6A or 6B is displayed on the display unit 108 of the information processing apparatus 101.

The print setting item screen illustrated in FIG. 7B includes a sheet type setting value list 704, a back button 705, and the close button 405.

The sheet type setting value list 704 displays setting values of sheet types available on the target printer.

When one of the setting values in the sheet type setting value list 704 is selected by the user, the sheet type setting value of the print settings stored in the print application is updated to the selected setting value, and the screen illustrated in FIG. 7A is then displayed on the display unit 108 of the information processing apparatus 101.

### <Processing Procedure>

In the present exemplary embodiment, a flowchart will be described that illustrates processing of the print application when a printer to be used for printing is selected and printing is performed using the photograph printing function. Processing in steps in the flowchart is performed by the CPU 103 executing programs stored in the ROM 104 and the external storage device 106. Like step numbers refer to like steps of the processing, and the redundant description will be omitted.

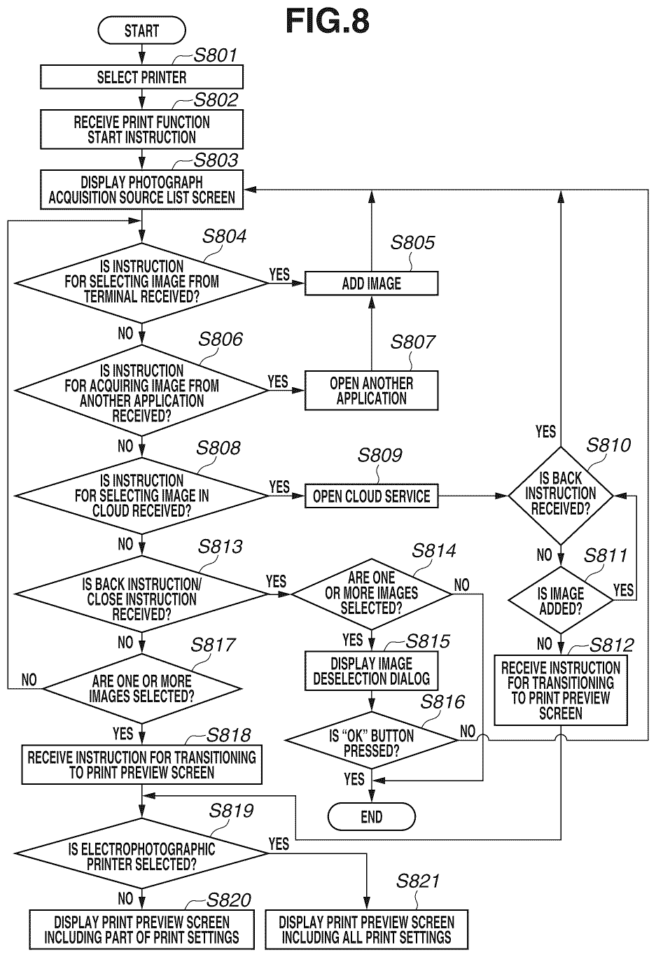

FIG. 8 illustrates a procedure from when the user starts using the print application to when the user reaches the print preview screen or terminates the photograph printing function. Especially, in the flowchart illustrated in FIG. 8, when the print setting button is pressed on the print preview screen, the screen transitions to the print setting screen and desired print setting items can be selected from the print setting item display area. It is on the assumption that the user uses the print application to select a target printer to which the print instruction is directed, and performs printing by using the photograph printing function. When the user starts the print application, the screen illustrated in FIG. 3 is displayed on the display unit 108 of the information processing apparatus 101. As illustrated in FIG. 3, the printer display area 301 that displays a printer selected as the target printer in the print application, and the function area 302 that displays the functions executable on the target printer are displayed on the display unit 108.

In step S801, the print application receives an instruction to select a printer to be used for printing from the printer display area 301. The print application searches for available printers, for example, using a wireless LAN, displays a list of discovered printers, and receives a selection from the user. The print application acquires printer information from the selected target printer, and stores the printer information in the print application.

In step S802, the print application receives an operation of the photograph printing function button 303, which issues an instruction to start the photograph printing function.

In step S803, in response to receiving the operation described in step S802, the print application displays the list screen of photograph acquisition sources illustrated in FIG. 4A on the display unit 108 of the information processing apparatus 101.

In I step S804, the print application determines whether an operation of the in-terminal image selection button 401 is received. If the operation is received (YES in step S804), the processing proceeds to step S805. If the operation of the in-terminal image selection button 401 is not received (NO in step S804), the processing proceeds to step S806.

In step S805, the print application displays the image selection screen illustrated in FIG. 5A on the display unit 108 of the information processing apparatus 101. The print application receives a user selection of the image to be printed from the image selection area 501. When the user presses the add button 503 after selecting an image, the print application stores the selected image. The processing proceeds to step S803. However, if no image is selected, the add button 503 cannot be pressed.

In step S806, the print application determines whether an operation of the in-another-application image selection button 402 is received. If the operation of the in-another-application image selection button 402 is received (YES in step S806), the processing proceeds to step S807. If the operation of the in-another-application image selection button 402 is not received (NO in step S806), the processing proceeds to step S808.

In step S807, another application is displayed on the information processing apparatus 101. The processing proceeds to step S805, and the print application stores the image selected in another application as the image to be printed.

In step S808, the print application determines whether an operation of the cloud-service image selection button 403 is received. If the operation is received (YES in step S808), the processing proceeds to step S809. If the operation of the cloud-service image selection button 403 is not received (NO in step S808), the processing proceeds to step S813.

In step S809, the print application displays a cloud-service image selection screen illustrated in FIG. 5B on the display unit 108 of the information processing apparatus 101. In step S810, the print application determines whether an operation of the back button 505 is received. If the operation of the back button 505 is received (YES in step S810), the processing proceeds to step S803. If the operation of the back button 505 is not received (NO in step S810), the processing proceeds to step S811.

In step S811, the print application receives a user selection of an image to be printed in the image selection area 504. If an image is selected (YES in step S811), the processing proceeds to step S810.

If no image is selected (NO in step S811), the processing proceeds to step S812.

In step S812, the print application receives an operation of the next button 506, which issue an instruction to transition to the print preview screen. The processing proceeds to step S819. However, if no image is selected in step S811, the operation of the next button 506 is not accepted.

In step S813, the print application determines whether an operation is received of either the back button 404, which transitions to the previous screen, or the close button 405, which terminates the photograph printing function. If the operation is received (YES in step S813), the processing proceeds to step S814. If the operation of neither the back button 404 nor the close button 405 is received (NO in step S813), the processing proceeds to step S817.

In step S814, the print application determines whether one or more images are selected. If one or more images are selected (YES in step S814), the processing proceeds to step S815. If one or more images are not selected (NO in step S814), the procedure ends.

In step S815, the print application displays the image deselection dialog 408, the OK button 409, and the cancel button 410 on the screen of the display unit 108 of the information processing apparatus 101.

In step S816, the print application determines whether an operation of the OK button 409 is received. If the operation of the OK button 409 is received (YES in step S816), the procedure ends. If the operation of the cancel button 410 is received (NO in step S816), the processing proceeds to step S803.

In step S817, the print application determines whether one or more images are selected. If one or more images are selected (YES in step S817), the processing proceeds to step S818. If one or more images are not selected (NO in step S817), the processing proceeds to step S804.

In step S818, the print application receives an operation of the next button 407, which is used to issue an instruction to transition to the print preview screen.

In step S819, the print application determines whether the selected target printer is an electrophotographic printer based on the information on the target printer stored in the print application in step S801. If the selected target printer is an electrophotographic printer (YES in step S819), the processing proceeds to step S821. If the target printer is other than an electrophotographic printer (e.g., is an inkjet printer) (NO in step S819), the processing proceeds to step S820.

A list table of apparatus names and model names of electrophotographic printers and apparatus names and model names of inkjet printers is previously stored in the print application. The print application determines whether the target printer is an electrophotographic printer based on the apparatus name, the model name, and the list table. However, the determination method is not limited thereto, and it can be determined whether a predetermined character string is included in the apparatus name or the model name, or it can be determined based on capability information on the target printer. In this case, it is determined whether the target printer an electrophotographic printer. However, the determination is not limited thereto. It can be determined whether the target printer is an inkjet printer, or it can be determined whether the target printer is an office printer.

In step S820, the print application displays the print preview screen illustrated in FIG. 6A on the display unit 108 of the information processing apparatus 101. In this case, some of the main print settings alone are displayed.

In step S821, the print application displays the print preview screen illustrated in FIG. 6B on the display unit 108 of the information processing apparatus 101. In this case, more detailed print settings than those of the screen illustrated in FIG. 6A are displayed. In other words, a greater number of print setting items and the corresponding values are displayed compared with the screen illustrated in FIG. 6A.

The above-described processing in the flowchart changes the print settings displayed on the print preview screen depending on the target printer, which enables the user to appropriately check the print settings.

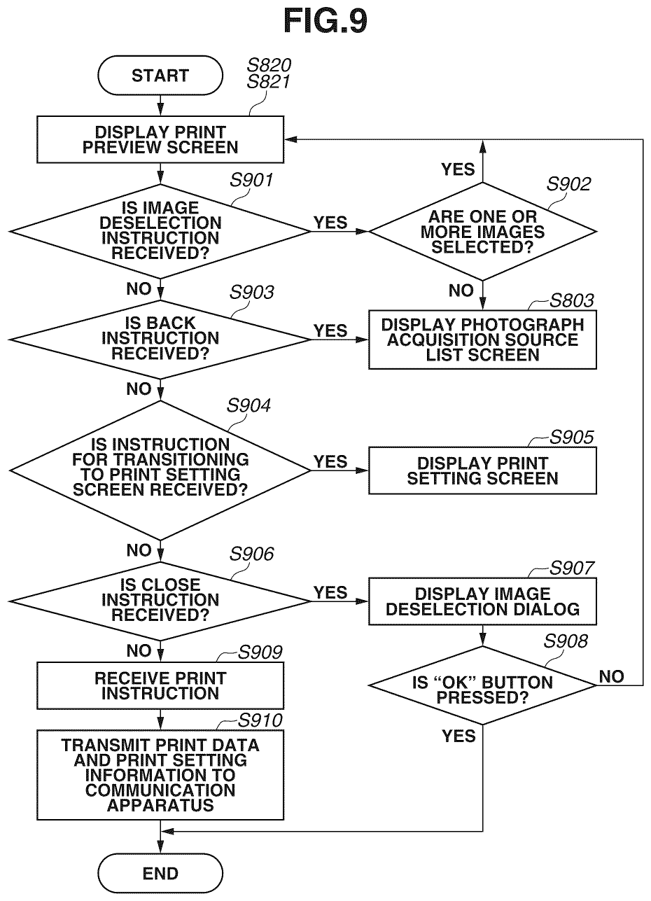

FIG. 9 illustrates a procedure from the display of the print preview screen to either the completion of printing or the transition to the print setting screen, or to the termination of the photograph printing function.

In step S901, after the print preview screen is displayed in step S820 or S821, the print application determines whether an operation of the image deselection button 602 is received. If the operation of the image deselection button 602 is received (YES in step S901), the image stored as the image to be printed is deselected, and the processing then proceeds to step S902. If the operation of the image deselection button 602 is not received (NO in step S901), the processing proceeds to step S903.

In step S902, the print application determines whether one or more images are selected as the image(s) to be printed. If one or more images are selected (YES in step S902), the processing proceeds to step S820 or S821. If one or more images are not selected (NO in step S902), the processing proceeds to step S803.

In step S903, the print application determines whether an operation of the back button 604 is received. If the operation of the back button 604 is received (YES in step S903), the processing proceeds to step S803. If the operation of the back button 604 is not received (NO in step S903), the processing proceeds to step S904.

In step S904, the print application determines whether an operation of the print setting button 605 is received. If the operation of the print setting button 605 is received (YES in step S904), the processing proceeds to step S905. If the operation of the print setting button 605 is not received (NO in step S904), the processing proceeds to step S906.

In step S905, the print application displays the print setting screen illustrated in FIG. 7A on the display unit 108 of the information processing apparatus 101. In this case, the print setting items included in the print setting screen remain unchanged irrespective of the target printer. However, the print setting items included in the print setting screen may vary depending on the target printer.

In step S906, the print application determines whether an operation of the close button 405 is received. If the operation of the close button 405 is received (YES in step S906), the processing proceeds to step S907. If the operation of the close button 405 is not received (NO in step S906), the processing proceeds to step S909.

In step S907, the print application displays the image deselection dialog 408, the OK button 409, and the cancel button 410 on the display unit 108 of the information processing apparatus 101.

In step S908, the print application determines whether an operation of the OK button 409 is received. If the operation of the OK button 409 is received (YES in step S908), the procedure ends. If the operation of the cancel button 410 is received (NO in step S908), the processing proceeds to step S820 or S821.

In step S909, the print application receives an operation of the print button 606, which is used to issue a print instruction to the printer.

In step S910, after the print button 606 is pressed in step S909, the print application transmits the stored image to be printed and the print setting information to the target printer (the communication apparatus 151).

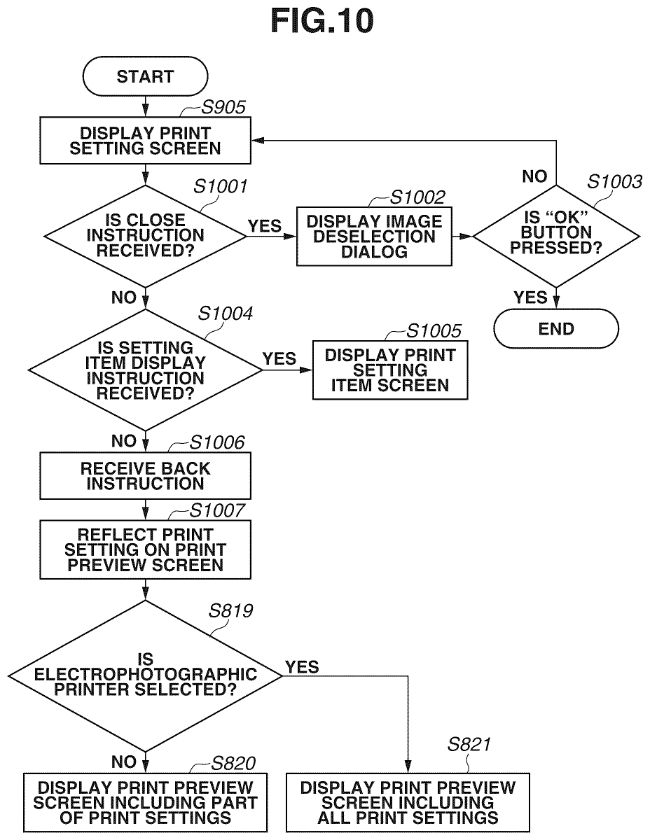

FIG. 10 illustrates a procedure from the display of the print setting screen in step S905 to either the return of the print preview screen or the display of the print setting item screen, or to the termination of the photograph printing function.

In step S1001, after the print setting screen is displayed in step S905, the print application determines whether an operation of the close button 405 is received. If the operation of the close button 405 is received (YES in step S1001), the processing proceeds to step S1002. If the operation of the close button 405 is not received (NO in step S1001), the processing proceeds to step S1004.

In step S1002, the print application displays the image deselection dialog 408, the OK button 409, and the cancel button 410 on the display unit 108 of the information processing apparatus 101.

In step S1003, the print application determines whether an operation of the OK button 409 is received. If the operation of the OK button 409 is received (YES in step S1003), the procedure ends. If the operation of the cancel button 410 is received (NO in step S1003), the processing proceeds to step S905.

In step S1004, the print application determines whether an operation of the print setting item button 702 is received. If the operation of the print setting item button 702 is received (YES in step S1004), the processing proceeds to step S1005. If the operation of the print setting item button 702 is not received (NO in step S1004), the processing proceeds to step S1006.

In step S1005, the print application displays the screen illustrated in FIG. 7B on the display unit 108 of the information processing apparatus 101. In this case, a list of the setting values corresponding to the print setting items selected on the print setting screen is displayed. The setting values set here are stored as the print setting information in the print application.

In step S1006, the print application receives an operation of the back button 703.

In step S1007, the print application reflects the print setting information stored in the print application in the print preview screen.

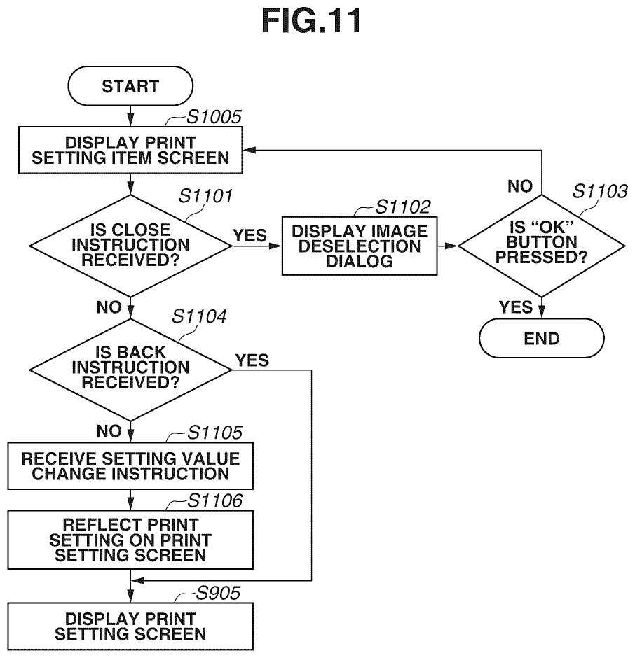

FIG. 11 illustrates a procedure from the display of the print setting item screen in step S1005 to the return to the print setting screen or the termination of the photograph printing function.

In step S1101, after the print setting item screen is displayed in step S1005, the print application determines whether an operation of the close button 405 is received. If the operation of the close button 405 is received (YES in step S1101), the processing proceeds to step S1102. If the operation of the close button 405 is not received (NO in step S1101), the processing proceeds to step S1104.

In step S1102, the print application displays the image deselection dialog 408, the OK button 409, and the cancel button 410 on the display unit 108 of the information processing apparatus 101.

In step S1103, the print application determines whether an operation of the OK button 409 is received. If the operation of the OK button 409 is received (YES in step S1103), the procedure ends. If the operation of the cancel button 410 is received (NO in step S1103), the processing proceeds to step S1005.

In step S1104, the print application determines whether an operation of the back button 705 is received. If the operation of the back button 705 is received (YES in step S1104), the processing proceeds to step S905. If the operation of the back button 705 is not received (NO in step S1104), the processing proceeds to step S1105.

In step S1105, the print application receives an instruction to change a setting value. For example, the user selects a desired setting value from the sheet type setting value list 704.

In step S1106, the print application stores the print setting information changed in step S1105 in the print application, and reflects the print setting information in the print setting screen.

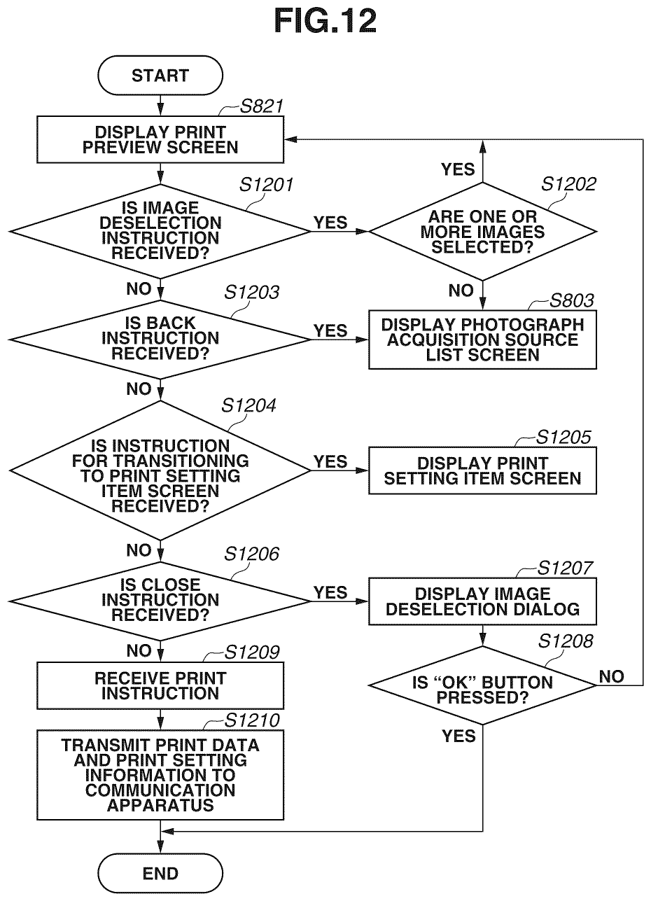

FIG. 12 illustrates a procedure from the display of the print preview screen to either the completion of printing or the transition to the print setting screen, or to the termination of the photograph printing function. Only if the target printer is an electrophotographic printer and the processing proceeds to step S821 after the processing in step S819, when an instruction to display the print setting item screen is received on the print preview screen, the print setting item screen can be directly displayed without displaying the print setting screen.

In step S1201, after the print preview screen is displayed in step S821, the print application determines whether an operation of the image deselection button 602 is received. If the operation of the image deselection button 602 is received (YES in step S1201), the processing proceeds to step S1202. If the operation of the image deselection button 602 is not received (NO in step S1201), the processing proceeds to step S1203.

In step S1202, the print application determines whether one or more images are selected. If one or more images are selected (YES in step S1202), the processing proceeds to step S821. If one or more images are not selected (NO in step S1202), the processing proceeds to step S803.

In step S1203, the print application determines whether an operation of the back button 604 is received. If the operation of the back button 604 is received (YES in step S1203), the processing proceeds to step S803. If the operation of the back button 604 is not received (NO in step S1203), the processing proceeds to step S1204.

In step S1204, the print application determines whether an operation of the print setting button 605 is received. If the operation of the print setting button 605 is received (YES in step S1204), the processing proceeds to step S1205. If the operation of the print setting button 605 is not received (NO in step S1204), the processing proceeds to step S1206.

In step S1205, the print application displays the print setting item screen illustrated in FIG. 7B on the display unit 108 of the information processing apparatus 101. The print application may display the print setting item screen corresponding to the print setting item selected from the print setting display field 603.

In step S1206, the print application determines whether an operation of the close button 405 is received. If the operation of the close button 405 is received (YES in step S1206), the processing proceeds to step S1207. If the operation of the close button 405 is not received (NO in step S1206), the processing proceeds to step S1209.

In step S1207, the print application displays the image deselection dialog 408, the OK button 409, and the cancel button 410 on the display unit 108 of the information processing apparatus 101.

In step S1208, the print application determines whether an operation of the OK button 409 is received. If the operation of the OK button 409 is received (YES in step S1208), the procedure ends. If the operation of the cancel button 410 is received (NO in step S1208), the processing proceeds to step S821.

In step S1209, the print application receives an operation of the print button 606, which is used to issue a print instruction to the printer.

In step S1210, after the print button 606 is pressed in step S909, the print application transmits the image to be printed stored in the print application and the print setting information to the communication apparatus 151.

As a result, when the communication apparatus 151 performs printing, the print setting item screen is directly accessed without displaying the print setting screen (e.g., the screen illustrated in FIG. 7A). This reduces the number of operation steps and user's burden.

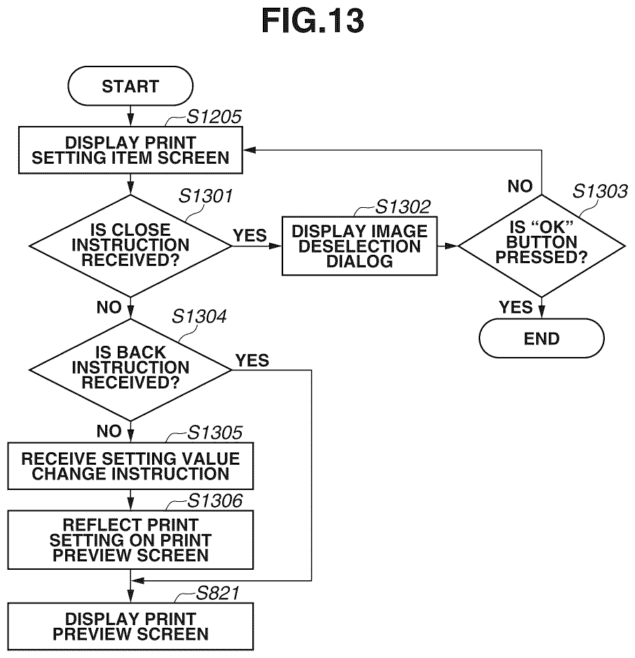

FIG. 13 illustrates a procedure from the display of the print setting item screen in step S1205 to the return to the print setting screen or the termination of the photograph printing function. Similar to the flowchart illustrated in FIG. 12, when the instruction to display the print setting item screen is received in the print preview screen, the print setting item screen can be directly displayed without displaying the print setting screen.

In step S1301, after the print setting item screen is displayed in step S1205, the print application determines whether an operation of the close button 405 is received. If the operation of the close button 405 is received (YES in step S1301), the processing proceeds to step S1302. If the operation of the close button 405 is not received (NO in step S1301), the processing proceeds to step S1304.

In step S1302, the print application displays the image deselection dialog 408, the OK button 409, and the cancel button 410 on the display unit 108 of the information processing apparatus 101.

In step S1303, the print application determines whether an operation of the OK button 409 is received. If the operation of the OK button 409 is received (YES in step S1303), the procedure ends. If the operation of the cancel button 410 is received (NO in step S1303), the processing proceeds to step S1205.

In step S1304, the print application determines whether an operation of the back button 705 is received. If the operation of the back button 705 is received (YES in step S1304), the processing proceeds to step S821. If the operation of the back button 705 is not received (NO in step S1304), the processing proceeds to step S1305.

In step S1305, the print application receives an instruction to change a setting value.

In step S1306, the print application stores in the print application the print setting information changed in step S1305, and reflects the print setting information in the print preview screen.

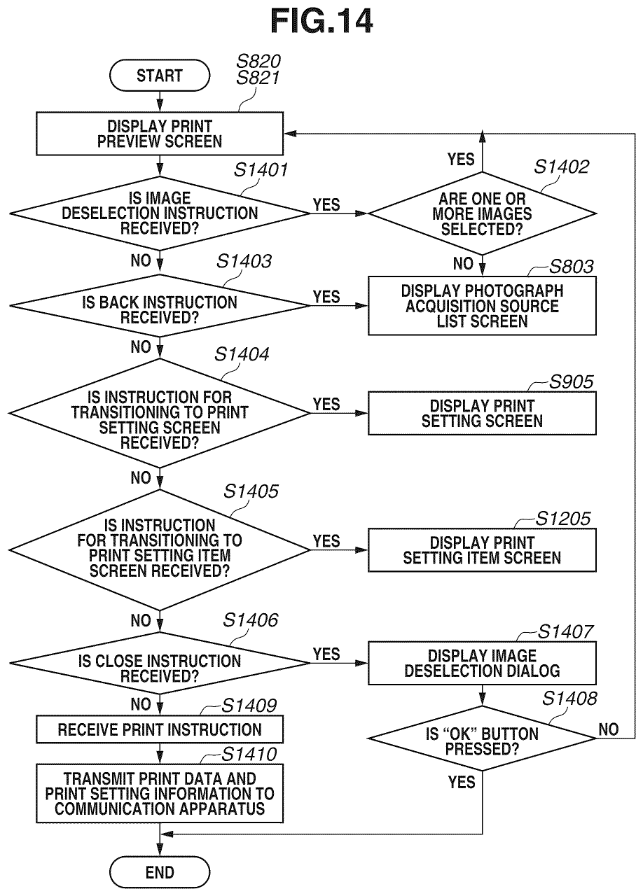

FIG. 14 illustrates a procedure from the display of the print preview screen to either the completion of printing or the transition to the print setting screen, or to the termination of the photograph printing function. In the procedure illustrated in FIG. 14, a print setting item button for each print setting item is provided in the print setting display field 603 separately from the print setting button 605. When an operation of the print setting item button is received, the corresponding print setting item screen is displayed without displaying the print setting screen. When the print setting button is pressed, the screen transitions to the print setting screen.

In step S1401, after the print preview screen is displayed in step S820 or S821, the print application determines whether an operation of the image deselection button 602 is received. If the operation of the image deselection button 602 is received (YES in step S1401), the processing proceeds to step S1402. If the operation of the image deselection button 602 is not received (NO in step S1401), the processing proceeds to step S1403.

In step S1402, the print application determines whether one or more images are selected. If one or more images are selected (YES in step S1402), the processing proceeds to step S820 or S821. If one or more images are not selected (NO in step S1402), the processing proceeds to step S803.

In step S1403, the print application determines whether an operation of the back button 604 is received. If the operation of the back button 604 is received (YES in step S1403), the processing proceeds to step S803. If the operation of the back button 604 is not received (NO in step S1403), the processing proceeds to step S1404.

In step S1404, the print application determines whether an operation of the print setting button 605 is received. If the operation of the print setting button 605 is received (YES in step S1404), the processing proceeds to step S905. If the operation of the print setting button 605 is not received (NO in step S1404), the processing proceeds to step S1405.

In step S1405, the print application determines whether an operation of the print setting item button is received. If the operation of the print setting item button is received (YES in step S1405), the processing proceeds to step S1205. If the operation of the print setting item button is not received (NO in step S1405), the processing proceeds to step S1406.

In step S1406, the print application determines whether an operation of the close button 405 is received. If the operation of the close button 405 is received (YES in step S1406), the processing proceeds to step S1407. If the operation of the close button 405 is not received (NO in step S1406), the processing proceeds to step S1409.

In step S1407, the print application displays the image deselection dialog 408, the OK button 409, and the cancel button 410 on the display unit 108 of the information processing apparatus 101.

In step S1408, the print application determines whether an operation of the OK button 409 is received. If an operation of the OK button 409 is received (YES in step S1408), the procedure ends. If an operation of the cancel button 410 is received (NO in step S1408), the processing proceeds to step S820 or S821.

In step S1409, the print application receives an operation of the print button 606, which is used to issue a print instruction to the printer.

In step S1410, after the print button 606 is pressed in step S1409, the print application transmits the image to be printed stored in the print application and the print setting information to the communication apparatus 151.

The print setting items displayed in the print setting display field 603 can directly transition to the corresponding print setting item screen to configure settings in response to receiving an instruction to transition to the corresponding print setting item screen. When the print setting items that are not displayed in the print setting display field 603 are configured, an instruction to transition to the print setting screen can be received and the screen can be switched to the print setting item screen via the print setting screen. This provides improved usability in configuring and checking print settings during printing on the communication apparatus 151.

### Other Exemplary Embodiments

In the above-described exemplary embodiment, the print setting information displayed on the print preview screen varies depending on the target printer, i.e., the target image processing apparatus. However, the display is not limited thereto, and a different print preview screen can be displayed depending on the target image processing apparatus. When a print instruction, as well as a scan instruction, is issued, scan setting information displayed on the preview screen for allowing the user to check the scan settings can vary depending on the target image processing apparatus.

The present disclosure can be implemented by supplying software (a program) that carries out the function of the above-described exemplary embodiment to a system or an apparatus via a network or various kinds of storage media, and causing a computer (or CPU or microprocessor unit (MPU)) of the system or the apparatus to read and execute the program. In this case, the computer program and the storage medium storing the computer program are included in the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-125976, filed Aug. 1, 2024, which is hereby incorporated by reference herein in its entirety.

What is claimed is:

1. A method of controlling an information processing apparatus that communicates with a printing apparatus, the method comprising:
acquiring information about the printing apparatus from the printing apparatus;
controlling the information processing apparatus to display a print preview screen for a user to check a print setting that has been changed based on the information about the printer that is acquired from the printing apparatus; and
instructing the printing apparatus to perform printing in response to a reception of an instruction to perform printing on the print preview screen.

2. The method according to claim 1, further comprising controlling the information processing apparatus to display a print setting screen for changing the print setting in response to a reception of a predetermined operation from the user on the print preview screen.

3. The method according to claim 2, further comprising controlling the information processing apparatus to display a print setting item screen including a setting value corresponding to a print setting item in response to a reception of a predetermined operation on the print setting screen.

4. The method according to claim 2, further comprising reflecting a change to the print setting when the print setting is changed on the print setting screen.

5. The method according to claim 1, wherein a print setting item displayed on the print preview screen is changed based on the information about the printing apparatus acquired in the acquiring.

6. The method according to claim 1, wherein the print preview screen includes an image to be printed.

7. The method according to claim 1, wherein the print preview screen includes a display item to change the print setting.

8. The method according to claim 1, wherein when a number of print setting items displayed on the preview screen is an electrophotographic printing apparatus is greater than the number of print setting items displayed on the preview screen in a case where the printing apparatus is an inkjet printing apparatus.

9. The method according to claim 1, wherein the display controlling is executed by an application configured to instruct an apparatus to perform printing and scanning.

10. An information processing apparatus that communicates with a printing apparatus, the information processing apparatus comprising:
at least one memory storing instructions; and
at least one processor that, upon execution of the stored instructions, is configured to operate as:
an acquisition unit configured to acquire information about the printing apparatus from the printing apparatus;
a control unit configured to control the information processing apparatus to display a print preview screen for a user to check a print setting that has been changed based on the information about the printer that is acquired from the printing apparatus; and
an instruction unit configured to instruct the printing apparatus to perform printing in response to a reception of an instruction to perform printing on the print preview screen.

11. A non-transitory computer-readable storage medium that stores a program that, when executed by at least one processor of an information processing apparatus that communicates with a printing apparatus, executes a control method, the control method comprising:
acquiring information about the printing apparatus from the printing apparatus;
controlling the information processing apparatus to display a print preview screen for a user to check a print setting that has been changed based on the information about the printer that is acquired from the printing apparatus; and
instructing the printing apparatus to perform printing in response to a reception of an instruction to perform printing on the print preview screen.
